(19) United States
(12) Patent Application Publication
(10) Pub. No.: US 2004/0186758 A1
(43) Pub. Date: Sep. 23, 2004

(54) System for bringing a business process into compliance with statutory regulations

(76) Inventors: Yilmaz Halac, Chicago, IL (US); Dhandapani Ramasamy, Oak Park, IL (US); Smita Patel, Hinsdale, IL (US); Norman R. Carpenter, Palatine, IL (US); Terrence R. Roberts, Chicago, IL (US); Cecelia R. Bolden, Chicago, IL (US); Aziz Lalani, Chicago, IL (US); Michael J. Szot, Chicago, IL (US); Vanay M. Shivaswamy, Lombard, IL (US)

Correspondence Address: BRINKS HOFER GILSON & LIONE, P.O. BOX 10395, CHICAGO, IL, 60610, US

(21) Appl. No.: 10/394,474

(22) Filed: Mar. 20, 2003

(51) Int. Cl. G06F 17/60

(52) U.S. Cl. 705/7

(57) ABSTRACT

A system and process are disclosed for analyzing a current state of compliance with a statutory regulation for a business process of an organization. The system includes establishing an administrator for the organization and obtaining structural information about the organization. A user is established related to the structural information. Questions are obtained about the business process from the administrator. The questions are distributed to the employee, an answer to the question is received from the employee, and a current level of compliance is generated based on the answer.

### BACKGROUND

The present invention relates generally to analyzing a current state of business processes' compliance with a given set of standards and developing an action plan to meet those standards. The healthcare industry is one example of industry currently in need of updating business process to comply with new statutory requirements.

In this age of information, the need for security and confidentiality of medical records has become a major concern for healthcare providers. As a result, the Health Insurance Portability and Accountability Act (“HIPAA”) of 1996, (August 21), Public Law 104-191, which amends the Internal Revenue Service Code of 1986, went into effect on Jul. 1, 1996. HIPAA is also known as the Kennedy-Kassebaum Act. HIPAA is a mandate that requires new standards for identifiers, security, privacy, transactions, code sets, and more. Title I of HIPAA protects health insurance coverage for workers and their families when they change or lose their jobs. Title II of HIPAA, the Administrative Simplification Provisions of the act, requires the Department of Health and Human Services to establish national standards for electronic health care transactions, national identifiers for providers, health plans and employers, and the security and privacy of “individually identifiable health information”, past, present, or future.

The HIPAA mandates went into effect in 2001 with compliance required in phases by 2004. Healthcare organizations are required to meet the HIPAA guidelines based on the regulatory schedule. Moreover, HIPAA calls for severe civil and criminal penalties for noncompliance. Failure to comply with a regulation results in a $100 penalty, with a maximum penalty of $25,000 for repeated violations of the same regulation. Additionally, the wrongful disclosure of Individual Identifiable Health information can result in a $50,000 fine, imprisonment of not more than one year, or both. A wrongful disclosure offense under false pretenses can result in a $100,000 fine, imprisonment of not more than 5 years, or both. Finally, a wrongful disclosure offense with intent to sell the information can result in a $250,000 penalty, imprisonment of not more than 10 years, or both. With all the complicated steps to comply with the HIPAA requirements and the large penalties for failing to do so, there is a need for a simple, comprehensive one-stop shop for HIPAA compliancy.

Furthermore, in times of ever-increasing security, other statutory or private privacy measures may be implemented. It will become important to ensure compliance with such rules is met as well.

Therefore, there is a need for a system that addresses the complex problems associated with bringing a business process into compliance with statutory regulations, such as HIPAA compliancy, and other problems in the art.

### BRIEF SUMMARY

A system and process are disclosed for analyzing a current state of compliance with a statutory regulation for a business process of an organization. The process includes establishing an administrator for the organization and obtaining structural information about the organization. A user is established related to the structural information. Questions are obtained about the business process from the administrator. The questions are distributed to the employee, an answer to the question is received from the employee, and a current level of compliance is generated based on the answer.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

FIG. 1 is a flow chart of a method for analyzing a current state of compliance with a statutory regulation for a business process of an organization in accordance with one embodiment of the present invention.

FIG. 2A is a functional overview of a Command Center in accordance with one embodiment.

FIG. 2B is a system architecture of one embodiment of the Command Center of FIG. 1.

FIG. 3A is a login screen for the Command Center of FIG. 2A.

FIG. 3B is a welcome screen for the Command Center of FIG. 2A.

FIG. 4 is a main menu for a process management tool of the Command Center of FIG. 2A.

FIG. 5A is a main menu for the process tracking tool of FIG. 4.

FIG. 5B is process tool screen shot for the process management tool of FIG. 4.

FIG. 5C is a process editing screen for the process management tool of FIG. 4.

FIG. 5D is a process tracking screen for the process management tool of FIG. 4.

FIG. 5E is a cost tracking screen for the process management tool of FIG. 4.

FIG. 5F is a resource tracking screen for the process management tool of FIG. 4.

FIG. 6A is a user status report screen for the process management tool of FIG. 4.

FIG. 6B is a variance report screen for the process management tool of FIG. 4.

FIG. 6C is a high level gap analysis report screen for the process management tool of FIG. 4.

FIG. 7A is an entity information screen for a compliance toolkit of the Command Center of FIG. 2A.

FIG. 7B is a contact person information screen for a compliance toolkit of the Command Center of FIG. 2A.

FIG. 7C is a level 1 compliance submission screen for a compliance toolkit of the Command Center of FIG. 2A.

FIG. 7D is a level 2 compliance submission screen for a compliance toolkit of the Command Center of FIG. 2A.

FIG. 7E is a level 3 compliance submission screen for a compliance toolkit of the Command Center of FIG. 2A.

FIG. 7F is a technical security services compliance submission screen for a compliance toolkit of the Command Center of FIG. 2A.

FIG. 8A is a month view screen for showing an event schedule for a calendar tool of the Command Center of FIG. 2A.

FIG. 8B is a daily view screen for a calendar tool of the Command Center of FIG. 2A.

FIG. 8C is a user level event view screen for a calendar tool of the Command Center of FIG. 2A.

FIG. 8D is an event confirmation screen for a calendar tool of the Command Center of FIG. 2A.

FIG. 8E is an administrator level setup screen for a calendar tool of the Command Center of FIG. 2A.

FIG. 9A is an administrator welcome screen for a data acquisition tool of the Command Center of FIG. 2A.

FIG. 9B is a user information screen for the data acquisition tool of FIG. 9A.

FIG. 9C is a question assignment screen for the data acquisition tool of FIG. 9A.

FIG. 9D is a question set editing screen for the data acquisition tool of FIG. 9A.

FIG. 9E is a question editing screen for the data acquisition tool of FIG. 9A.

FIG. 10A is a user level welcome and assignment screen for a data acquisition tool of the Command Center of FIG. 2A.

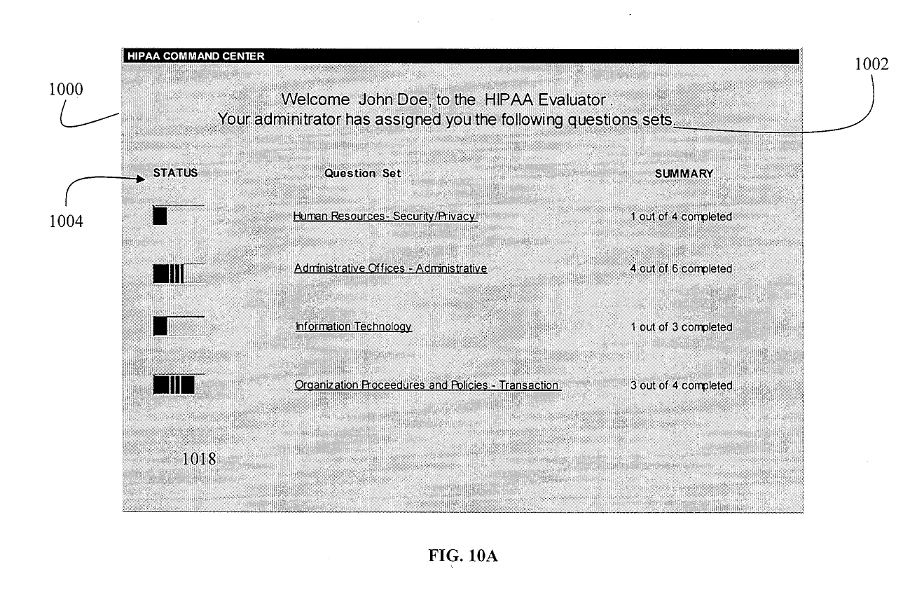

FIG. 10B is a question answer screen for a user in the data acquisition tool of FIG. 10A.

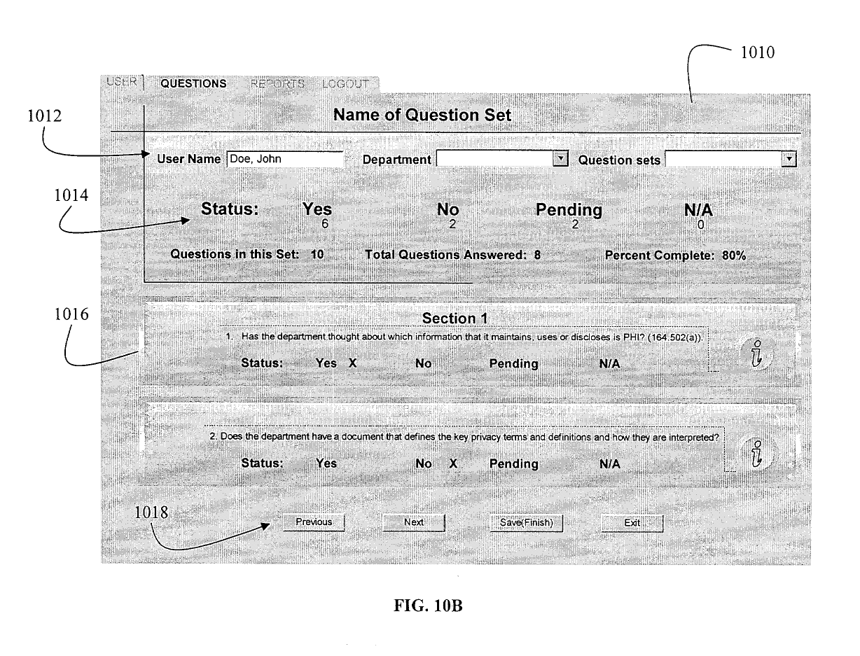

FIG. 10C is a question informational screen for a data acquisition tool of FIG. 10A.

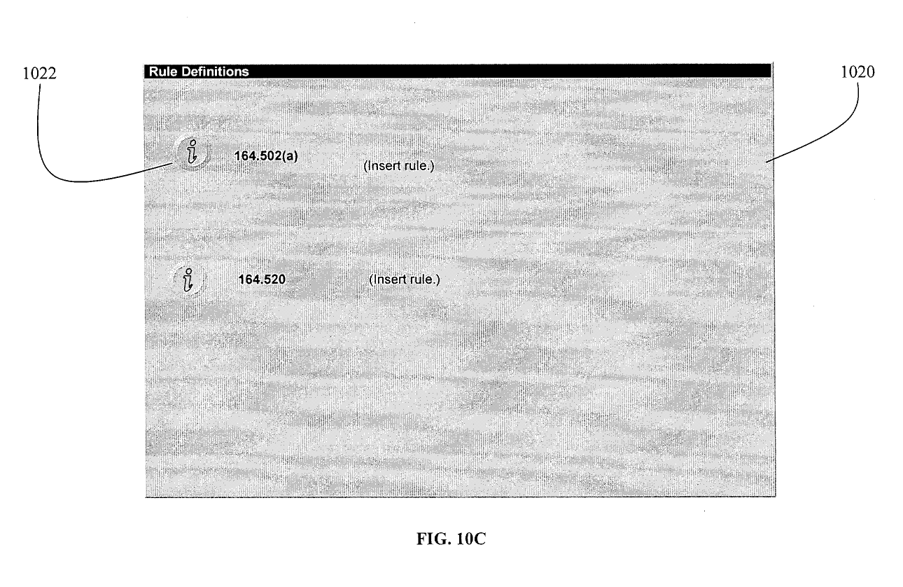

### DETAILED DESCRIPTION

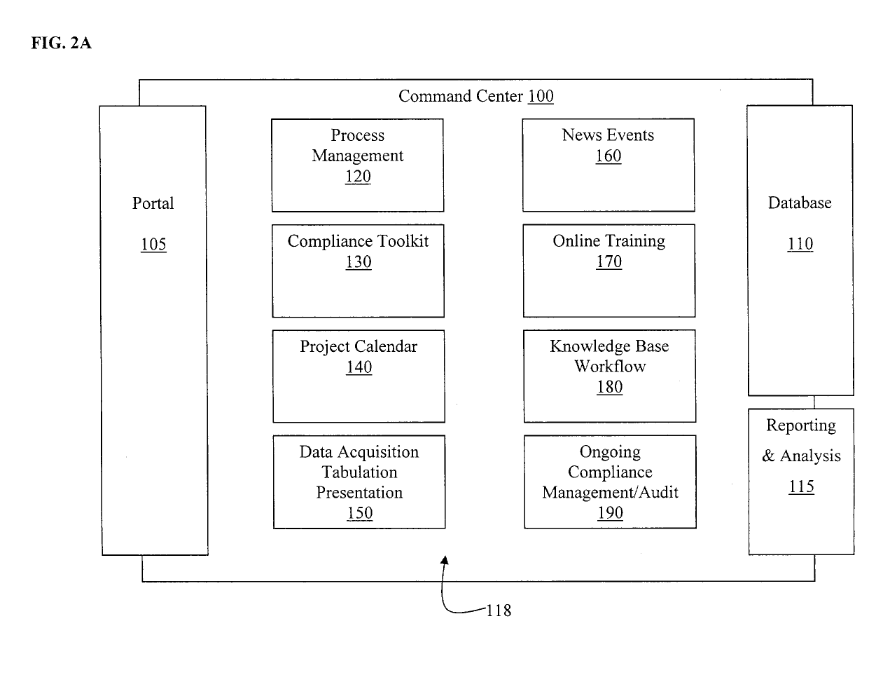

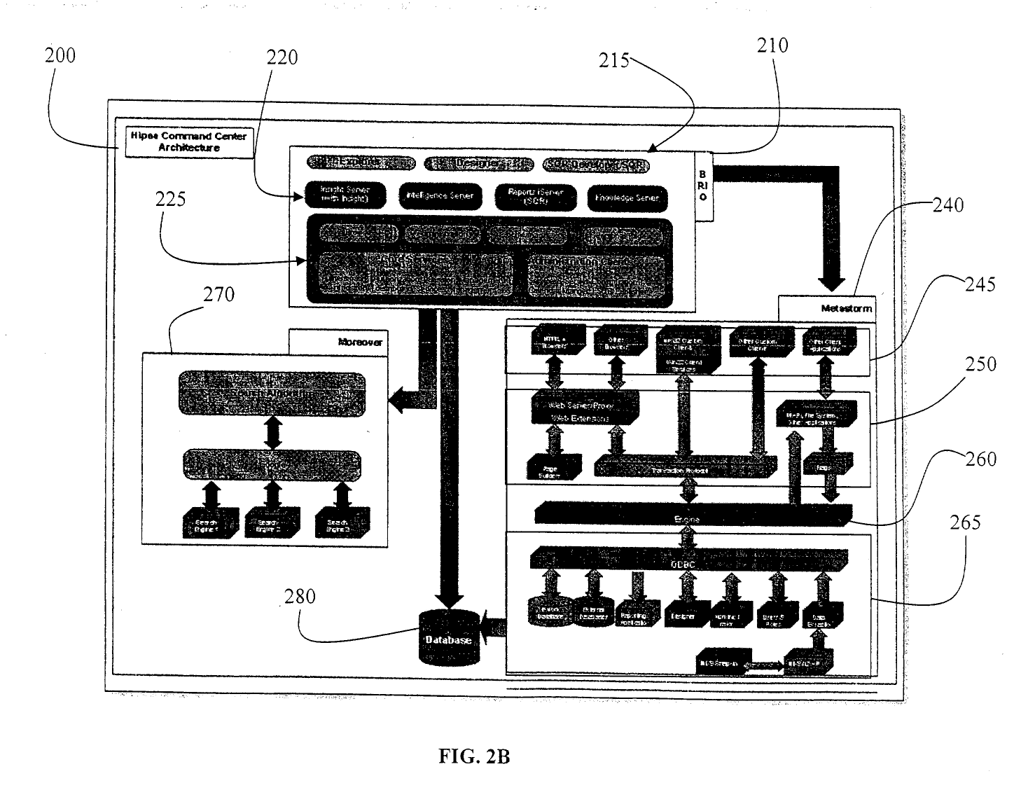

While the embodiments describe a system designed for healthcare organizations and providers, the system can be used by any organization attempting to bring its business processes in compliance with given standards. Referring now to the drawings and initially to FIG. 2A, a functional overview of a system in accordance with one embodiment is shown. A Command Center 100 is generally provided with a portal 105, a database 110, a Report and Analysis component 115, and functional area components 118. The functional area components 118 include Process Management 120, Compliance Toolkit 130, a Project Calendar 140, Data Acquisition/Tabulation/Presentation 150, News Events 160, Online Training 170, Knowledge Base Workflow 180, Ongoing Compliance Management/Audit 190, and the like.

The Command Center 100 includes a collection of tools designed to provide healthcare organizations with an integrated software package including the tools needed to evaluate and bring business processes into compliance with mandates, such as HIPAA mandates. Typical organizations in need of the tools provided in the Command Center 100 include healthcare organizations and providers, such as physician offices, health plan providers, employers, public health authorities, life insurers, clearinghouses, billing agencies, information systems vendors, service organizations, universities, and the like. The Command Center 100 can be used to establish organizational awareness, such as HIPAA awareness. The Command Center 100 can comprehensively assess the organization's information security systems, policies and procedures. Using the assessment, an action plan can be developed by the Command Center 100 which meets regulatory deadlines and timetables. The Command Center 100 can develop a technical and managerial infrastructure to implement a comprehensive action plan. The comprehensive action plan can include developing new policies, processes, and procedures; establishing a “chain of trust” with service organizations; redesigning a compliant technical information infrastructure; adapting or purchasing new information systems; developing new internal communications; and training and enforcement. The plan may optionally be adapted to interact with tools that support collaboration among teams and workgroups, using the accessibility and availability of information on intranets to promote broad participation in planning and to provide visibility to project information. Such tools include Microsoft Project™ and Microsoft Project Central™, provided by Microsoft Corporation of Redmond, Wash.

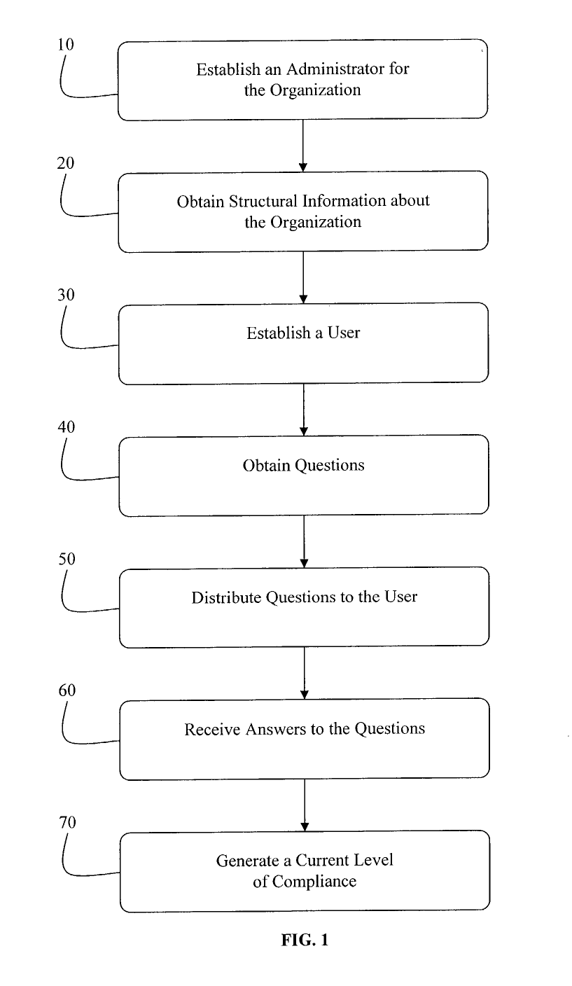

Referring to FIG. 1, initially an administrator is established for the organization at step 10. The administrator may be responsible for defining the structure of the organization, defining user information and compliance questions, assigning questions to users, submitting compliance information to authorities, such as HIPPA authorities and other health related regulatory XXXX, and managing a compliance action plan. Structural information about the organization is obtained at step 20. Under the framework of the Command Center 100, medical organizations can include departments and the departments can include one or more facilities. Exemplary departments in a healthcare organization may include Patient Registration, Division of Psychiatry, Department of Anesthesiology, Division of Cardiology, Division of Otolaryngology (ENT), Division of Endocrinology, Division of General Obstetrics & Gynecology, Division of Infectious Disease, and Division of Orthopedic Surgery. A very small organization could include one department and one facility or more facilities belonging to the one department. Using this structure, the Command Center 100 is capable of dealing with various medical organizations. For example, HIPAA requires that each facility reply to set of questions related to that facility. Analysis of these questions gives the organization administrator view of where the organization stands in meeting the requirements, for example HIPAA requirements.

Once the one or more departments and facilities have been defined, user information is entered at step 30. The Command Center 100 allows for various types of users. Users may be an administrator or a non-administrator. Examples of non-administrator users include employees, clients, or business associates, or any other person affiliated with the organization required to comply with the regulation. Regardless of the designation, the users are responsible for the compliance initiatives of a department and/or a facility. Additionally, a department/facility may have more than one user responsible for its compliance.

After the users have been defined for the department and/or facility, the administrator creates the compliance questions at step 40. The compliance questions are questions about the business processes and its current state of compliance with the regulation. For example, an exemplary question may include a question about including boilerplate language required by the regulation on a particular form. At the Command Center 100, questions are defined in question sets, and can belong to one or more question sets. Question sets, in turn, belong to sections. Each facility includes one or more question sets, and each user is responsible for at least one question set. The questions can be of different types. In one embodiment, questions may be yes/no, text, multiple choice or check all that apply type questions. Once a question set is defined, it is assigned and distributed to a user at step 50.

Next, users answer the questions and the Command Center receives the response at step 60. Users respond to questions based on the type of question. For example, yes/no questions are answered by selecting yes or no answers. Preferably, questions are defined with discrete answer choices to maximize the automation of reports and calculations, but essay-type questions can also be used. The functionality of entering user and question information and receiving responses to those questions from the users is described in more detail below. Once questions have been answered, a current level of compliance is generated.

The portal 105 includes a user interface accessible through a web browser that preferably allows users to search for and retrieve information, and execute jobs and queries. For example, the portal 105 may be a java based thin-client Java-based client. It should be appreciated by one of skill in the art that many other types of interfaces, such as terminals, stand-alone applications, and the like are contemplated by the present invention. The database 115 includes a relational database used to store the information used by the system. The reporting and analysis tool 110 is a collection of tools used to access information in the database 115 and generate reports based on the information. In one embodiment, the portal 105 and the reporting and analysis tool 110 are part of an integrated tool that is programmable to incorporate the business logic associated with the Command Center 100. In one embodiment, the portal is provided as an implementation of the Brio Performance Suite 8™ software provided by Brio Software of Santa Clara, Calif., with search capabilities provided as an implementation of the Connected Intelligence™ software provided by Moreover Technologies of San Francisco, Calif.

FIG. 2B shows the system architecture 200 of one embodiment of a Command Center 100. The system 200 includes a first architecture 210, a second architecture 240, and a third architecture 270, such as Brio™, Metastorm™ and Moreover™, respectively, and a database 280 that is comparable to the database 110 of FIG. 2A. The first architecture 210 provides the portal 105 and reporting and analysis functionality of the Command Center 100. The architecture may include developmental tools 215, client tools 220, and services 225. In one embodiment, the developmental tools 215 includes an explorer tool for interacting with the portal 105, a designer tool for designing the layout of the portal 105, and an SQR developer tool that allows developers to incorporate Structured Query Report (SQR) functionality into the portal 105. The client tools 220 may include an Insight Server that enables users to create queries, analyze data and create reports over the web, an Intelligence Server that allows a user to view files and jobs through the portal 105, a Reports iServer that provide users with complex report layouts and easy to use reporting tools, and a Knowledge Server that provides a fully automated search engine for finding and retrieving information. Services 225 may include browse services that define the operations of the portal 105, Administration services that allow one to administrate the portal 105, Job Manager services that manage executable objects such as reports and programs, and Personal Pages that allow the user to customize the portal 105. Additionally, Core Services may be provided to authenticate users, grant authorization to users, manage user-sessions, interact with the database 280, and manage distributed services. Client administration services may also be provided to configure services and servlets, manage the Project Calendar 140, and publish SQR data.

The second architecture 240 provides the framework for the Knowledge Base Workflow 170, discussed below. In one embodiment, the second architecture 240 includes client tools 245, communication tools 250, an engine 260, and data storage tools 265. The client tools 245 may include client adapters for HTML 4 browsers or other browsers, win32 clients or other client types. The communication tools 250 include tools for communicating with the various types of clients. Such tools may include web-based tools, protocol tools, for example transaction protocol tools, and tools for interacting with specific applications, such as a messaging application programming interface (MAPI) or file system. The engine 260 provides the tools for the Workflow Knowledge Base 170. The data storage tools 265 store the information, and may include an open database connectivity (ODBC) tool and various tools that interact with the database.

The third architecture 270 provides time-sensitive information about the regulations to the portal 105, such as HIPAA information. The third architecture 270 can be configured to provide live headline links on any company, topic, or industry, delivered continuously and automatically to the portal 105. The third architecture 270 can also provide fully integrated keyword search capability accessible through the portal 105. In one embodiment, the third architecture 270 may include a search algorithm that utilizes various Internet or intranet search engines.

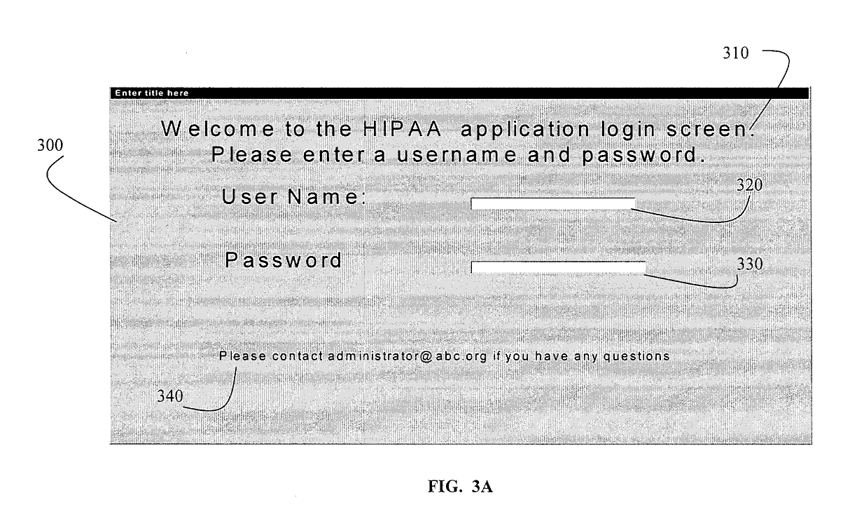

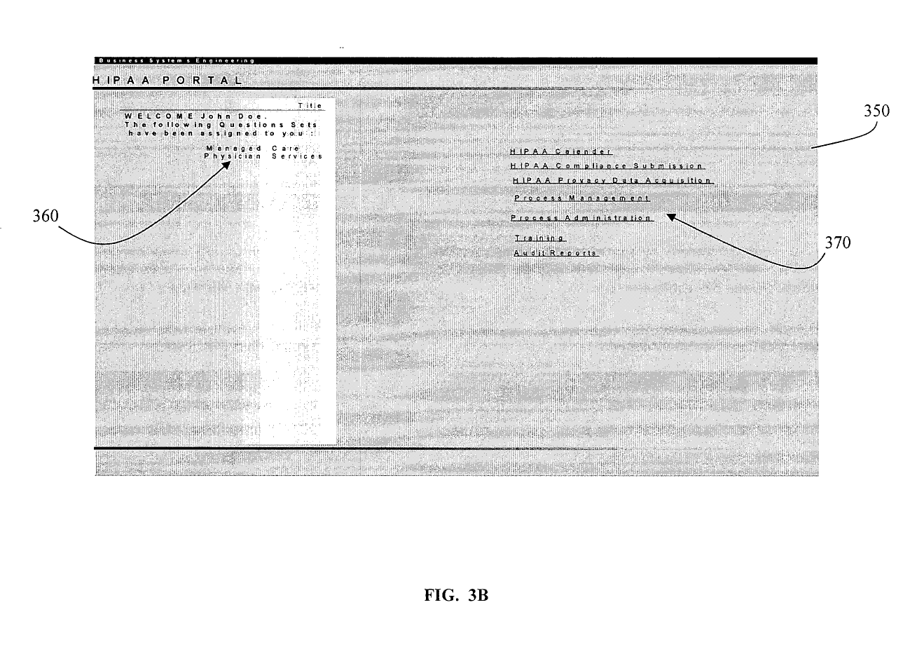

FIGS. 3A-B show the login 300 and welcome 350 screens of a portal 105. To access the functionality of the Command Center 100, a user preferably logs in. FIG. 3A shows a login screen 300. The login screen 310 contains a welcome text 310, which may include instructional information for the user. In one embodiment, message text 310 informs the user to enter username and password information. The login screen 310 also includes text boxes 320 and 330 that allow a user to input username and password information. The username and password information is then validated. If the information is invalid, an error message may be displayed. Optionally, the login screen 300 may include contact information 340 that provides administrator information to the user. If the information is valid, the user is directed to the welcome screen 350.

The welcome screen 350 is shown in FIG. 3B. The welcome screen 350 includes welcome text 360, which may include a welcome message and list the questions that have been assigned to that user, as described below. Additionally, the welcome screen 350 includes function buttons 370 that provide access to the functional areas 118 of the Command Center 100. Optionally, a user may only be provided with the function buttons 370 that correspond to access rights of the user.

Process Management

The Process Management tool 120 (PM) is a collection of tools that centralizes and organizes access to regulation information, such as HIPAA information. For example, PM 120 outlines the steps of the HIPAA compliance process, displaying to the user the pertinent resources and the latest information. In other words, PM 120 provides a roadmap to compliance and centralizes information in a comprehensive action plan. PM 120 allows the team to coordinate efforts and includes analysis tools, sample forms and surveys. The tool allows tracking of costs and efficiency in each phase of the HIPAA implementation. The PM 120 helps capitalize on the strategic opportunities that can result from leveraging compliance, while the information provided by the tool is helpful in proving due diligence and compliance efforts.

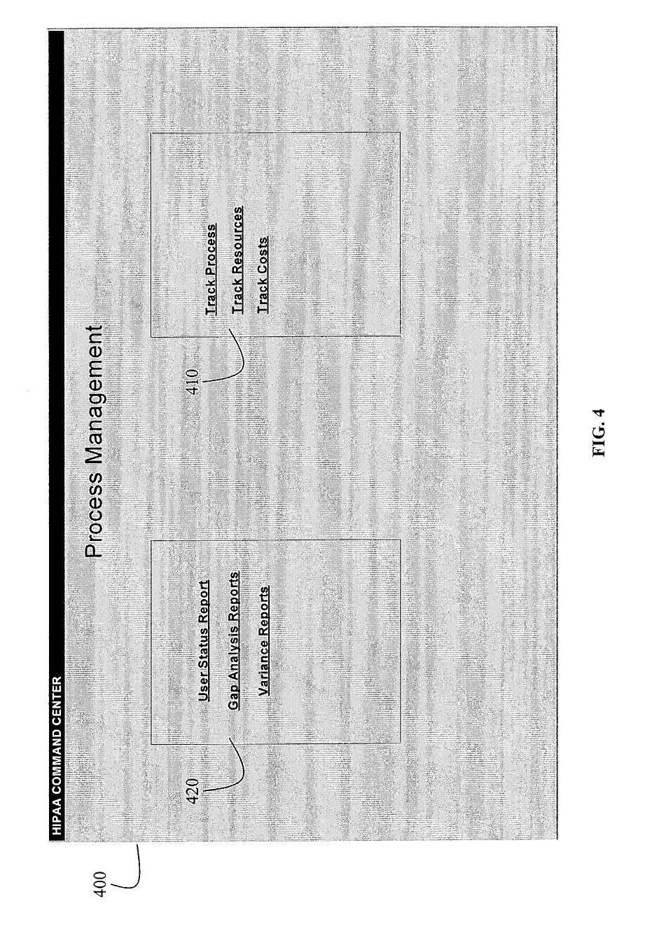

FIG. 4 shows the PM 120 main screen 400. The main screen 400 provides an administrator with a central location to access the tools associated with management of a business process. The tools are organized into tacking tools 410 and reporting tools 420. In one embodiment, the tools are accessible via hyperlinks. Clicking on a hyperlink will direct a user to the main screen associated with that tool. In one embodiment, an administrator can track processes, resources and costs, as discussed below. Additionally, user status, gap analysis, and variance reports are accessible through the main screen 400 of the PM 120, described below.

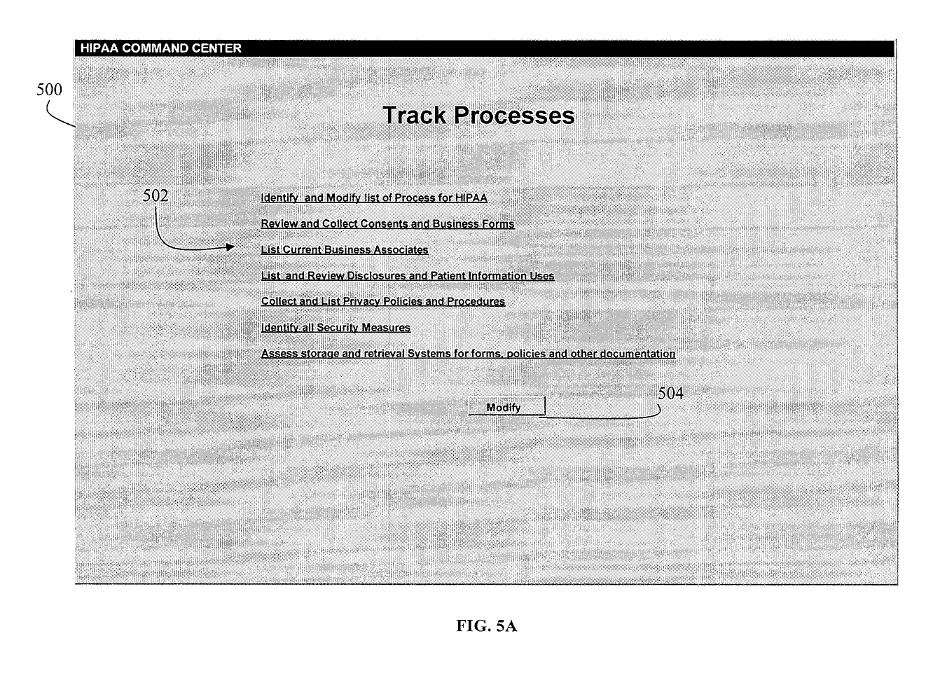

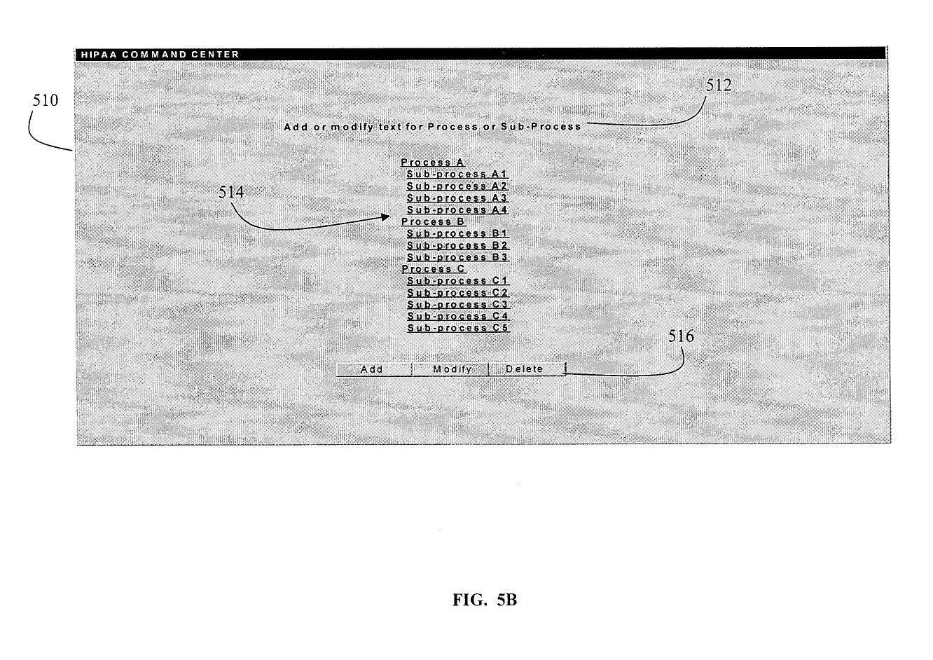

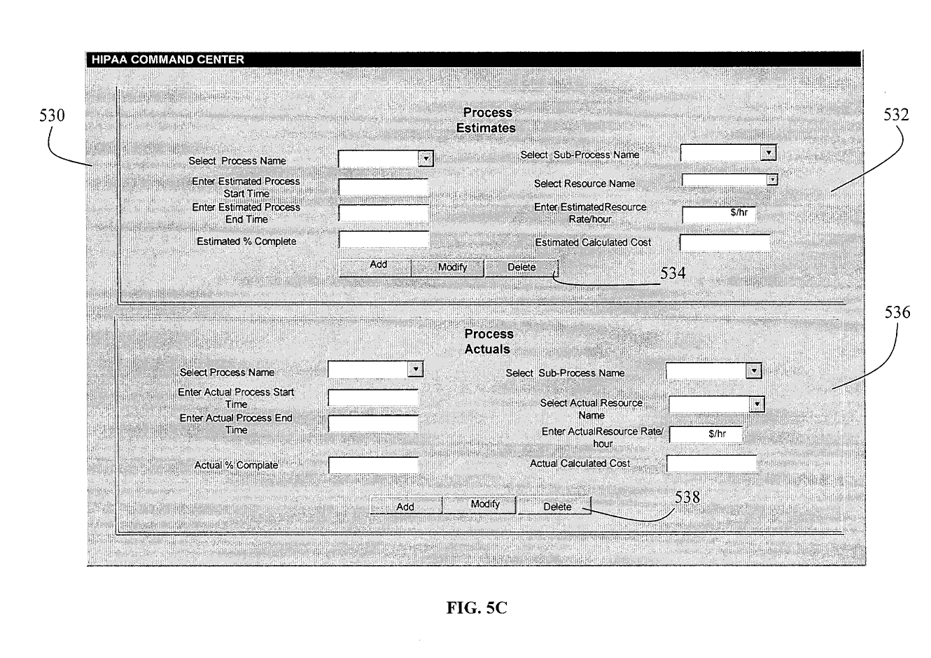

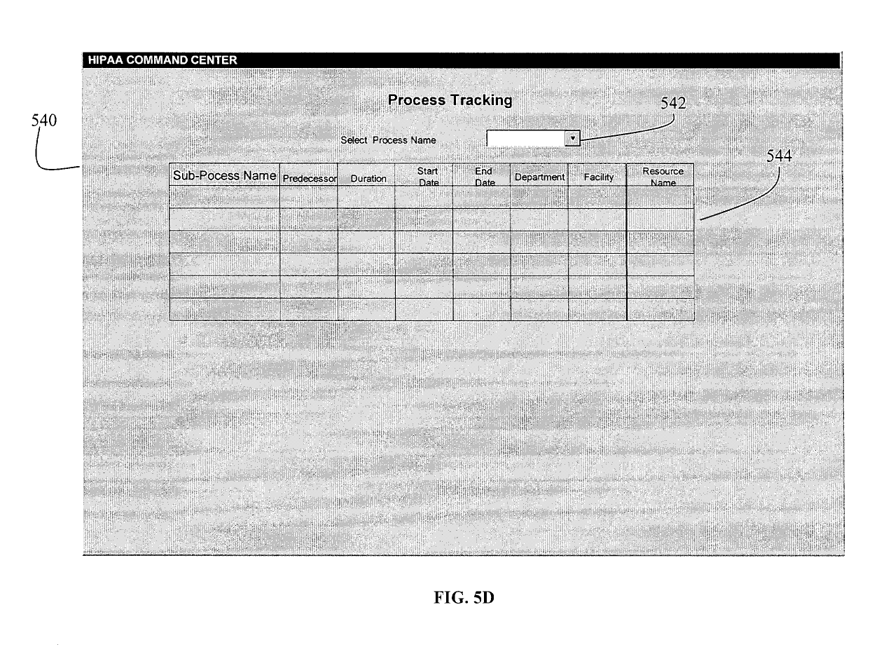

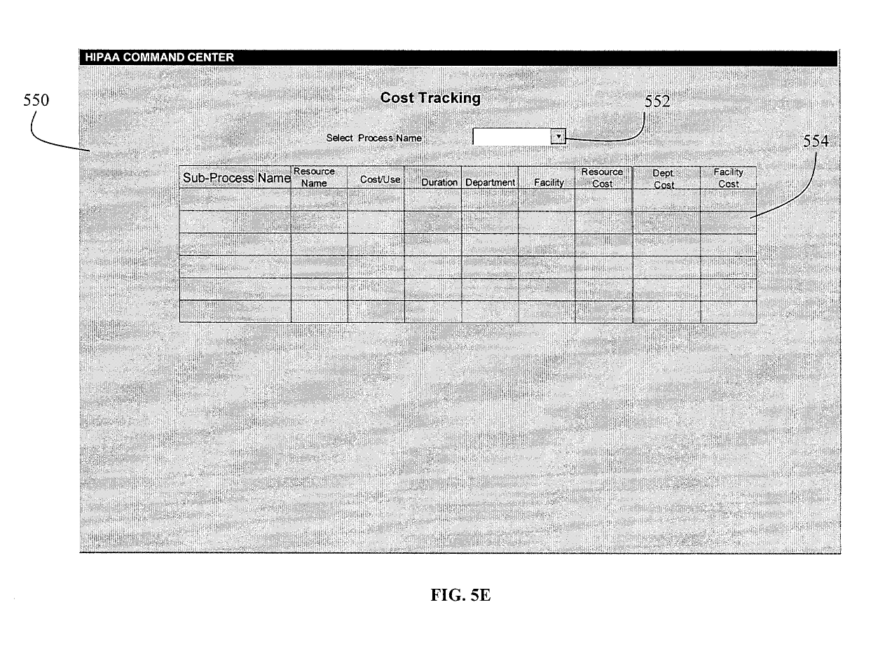

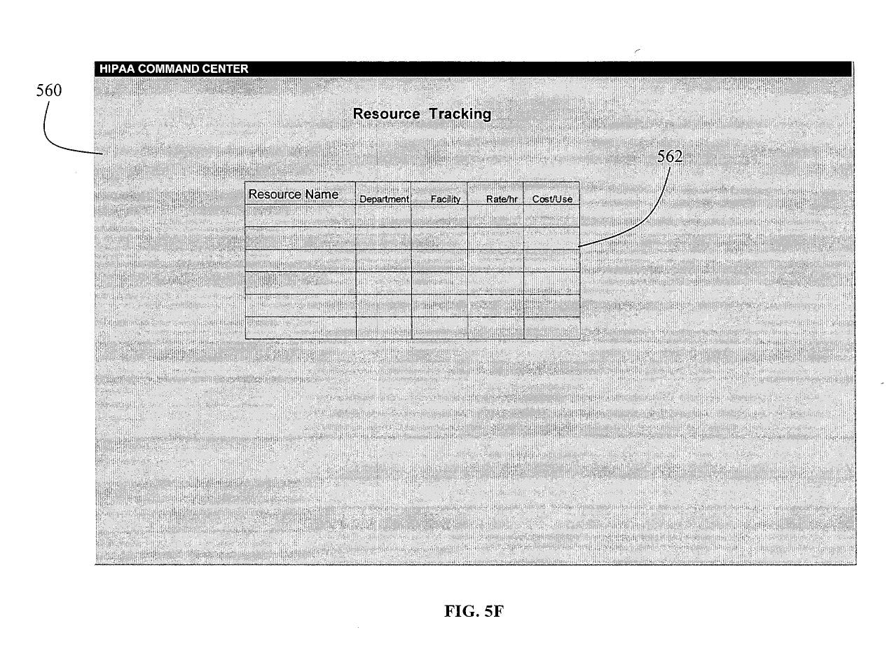

FIGS. 5A-G show the tracking features of the PM in accordance with one embodiment. FIG. 5A shows the main screen 500 of the process tracking tools. A list of tools 502 is provided as hypertext links. Clicking on a link will direct the user to the screen associated with the particular process tracking tool. In one embodiment, a user may identify and modify the list of processes for the Command Center 100, review and collect consents and business forms, list current business associates, list and review disclosures and patient information uses, collect and list privacy policies and procedures, identify all security measures, and access storage and retrieval systems for forms, policies and other documentation. Navigation button 504 allows the administrator to modify the CONTENT OF THE ITEM SELECTED.

FIG. 5B show the functionality of the tool used to identify and modify the list of processes. The main screen 510 for the tool to identify and modify the list of processes contains title information 512 that indicates which tool a user has accessed. A process list 514 displays a list of the currently defined processes and sub-processes. Depending on the complexity of a given process, a process may have multiple sub-processes associated with it. The processes and sub-processes are listed as hypertext links that direct the user to the process information screen 530 that corresponds to the selected process. Additionally, buttons 516 are provided that allow a user to add, modify or delete processes or sub-processes.

An exemplary process information screen 530 is shown in FIG. 5C. The process information screen 530 provides an interface for the user to input process estimate information 532 and process actuals information 536. The process estimate information 532 and the process actuals information 536 contain the same fields of information. However, the process estimate information 532 contains the estimate information for a selected process as determined by the administrator, while the process actuals information 536 contains the data reflective of actual progress as entered by the administrator. In one embodiment, process estimate information 532 and process actuals information 536 include fields for a process name, a sub-process name (where applicable), the estimated start time, the estimated end time, an estimated completion percentage, a resource name (where applicable), an estimated hourly rate for the resource (where applicable), and an estimated calculated cost. The estimated percent complete and estimated calculated costs are automated fields based on the other information provided. Optionally, a drop-down box is provided for the process and sub-process name fields. Buttons 534 and 538 are provided to allow the user to add, modify or delete the process estimate or actuals information.

The process tracking screen 540, shown in FIG. 5D, provides process tracking information. The screen 540 includes a pull down box 542 that contains defined processes. When a user selects a process from the pull down box 542, process tracking information table 544 displays the corresponding tracking information associated with the selected process. In one embodiment, the process tracking information table 544 displays the following information for each sub-process of the selected process (where applicable): predecessor information corresponding to a sub-process that is finished before the displayed sub-process can be executed; duration; actual start date; actual end date; department information; facility information; and resource name.

The cost tracking screen 550, shown in FIG. 5E, provides cost tracking information. The screen 550 includes a pull down box 552 that contains defined processes. Once a user selects a process from the pull down box 552, cost tracking information table 554 displays the corresponding tracking information, which had been previously entered, associated with the selected process. In one embodiment, the cost tracking information table 554 displays the following information for each sub-process of the selected process (where applicable): resource name; cost/use information; duration; department information; facility information; resource cost; department cost; and facility cost information.

The resource tracking screen 560, shown in FIG. 5F, provides resource tracking information. A resource tracking information table 562 displays the corresponding tracking information associated with the resources for the selected sub-process. In one embodiment, the resource tracking information table 562 displays the following information for each resource: resource name; department information; facility information; rate; and cost/use.

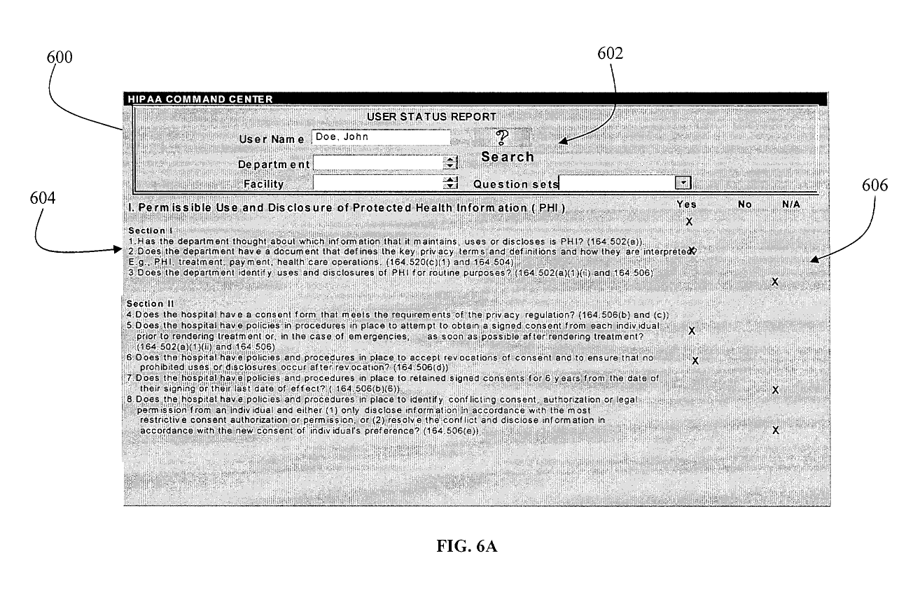

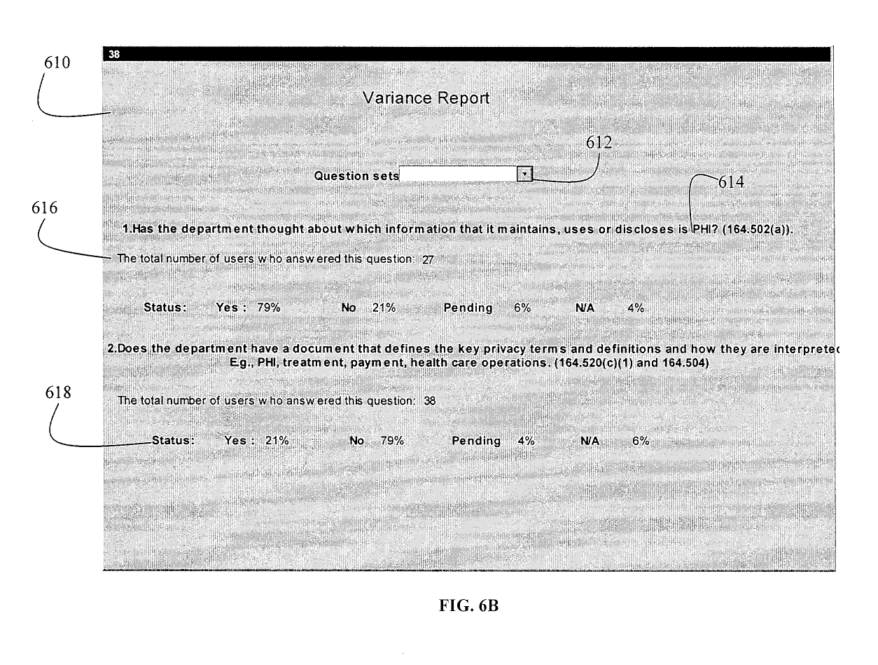

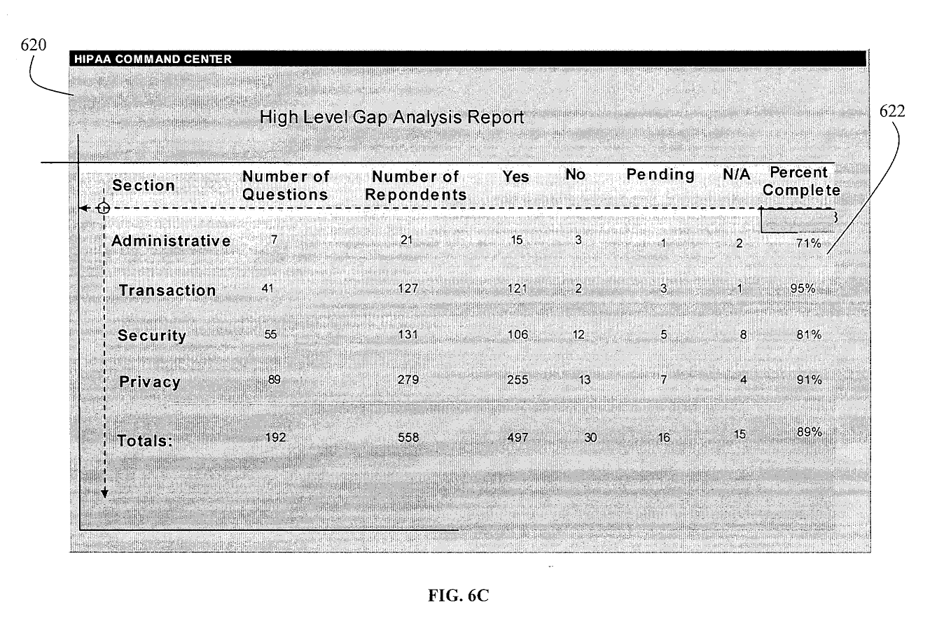

FIGS. 6A-C show exemplary reports accessible through the PM 120, for use by the administrator. As described above, a user status report, a variance report, and a gap analysis report are accessible through the main screen 400 of the PM 120. An exemplary user status report 600 is shown in FIG. 6A. The report includes a user selection interface 602, a question information table 604, and an answer information table 606. The user selection interface 602 contains a user name search field that allows an administrator to enter a user name and search the system for the questions that have been assigned to the user. If the user exists, the questions that have been assigned to that user will be displayed in question information table 604, with the corresponding answer information displayed in the answer information table 606. Alternatively, an administrator can select a particular department, facility, or question set from the corresponding dialogue box provided in the user selection interface 602. If selected, the question information table 604 and the answer information table 606 will display the questions and answers associated with the selected department, facility, or question set.

FIG. 6B shows an exemplary variance report 610 as viewed by the administrator. The report 610 includes a pull down box 612 containing defined question sets for selection by the administrator. Once a question set has been selected, the questions 614 associated with that set are displayed. For each question, the variance report 610 displays the total number of users who have answered that question as well as answer breakdown information 618.

FIG. 6C shows an exemplary gap analysis report. The gap analysis report 620 provides a breakdown of the overall results of all questions sorted topically. In one embodiment, the gap analysis report 620 is divided into administrative, transaction, security, and privacy questions. For each section, the table 622 displays the total number of questions, the total number of responses, the total ‘yes’ responses, the total ‘no’ responses, the total pending responses, the total non-applicable responses, and the percent complete. Additionally, overall totals are shown in the gap analysis report 620.

Compliance Toolkit

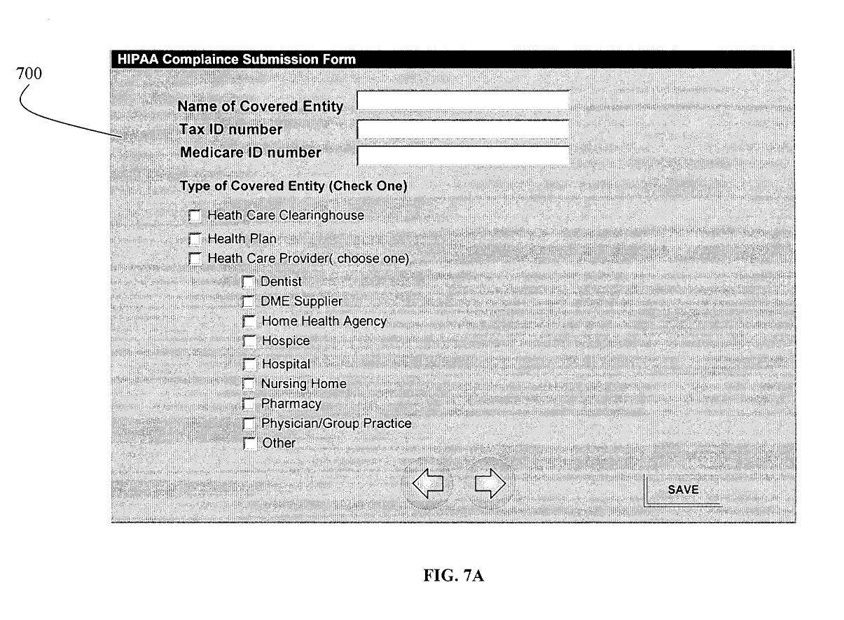

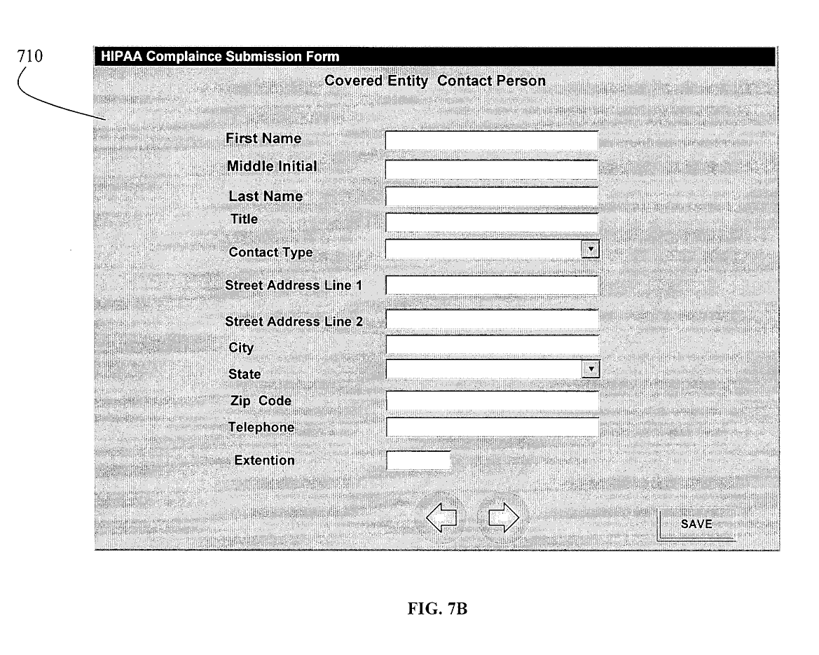

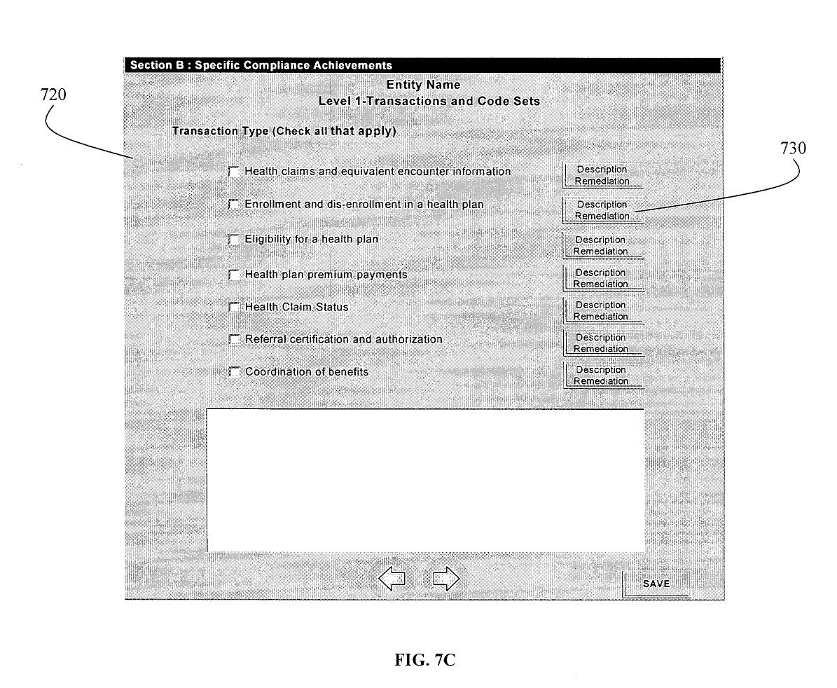

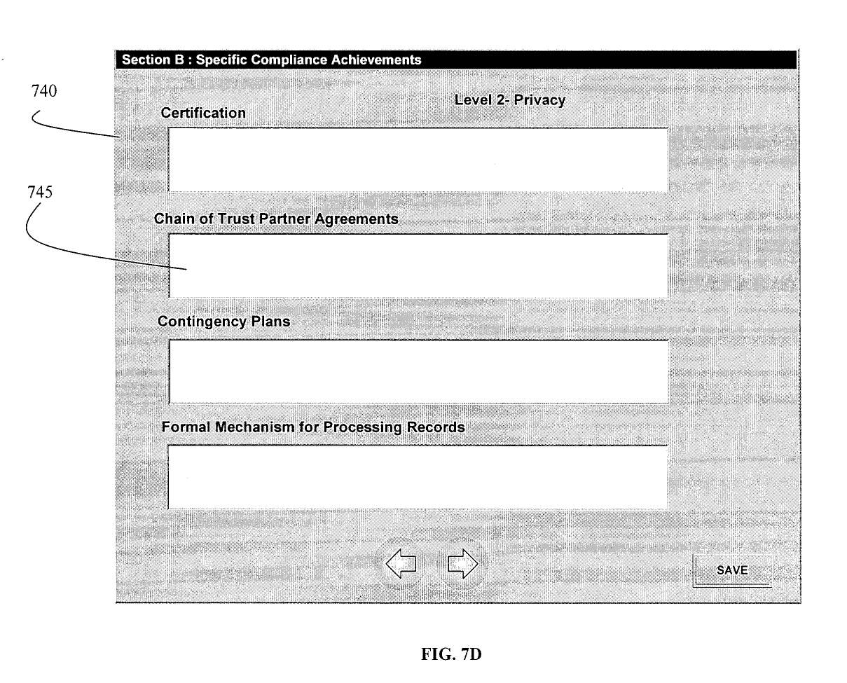

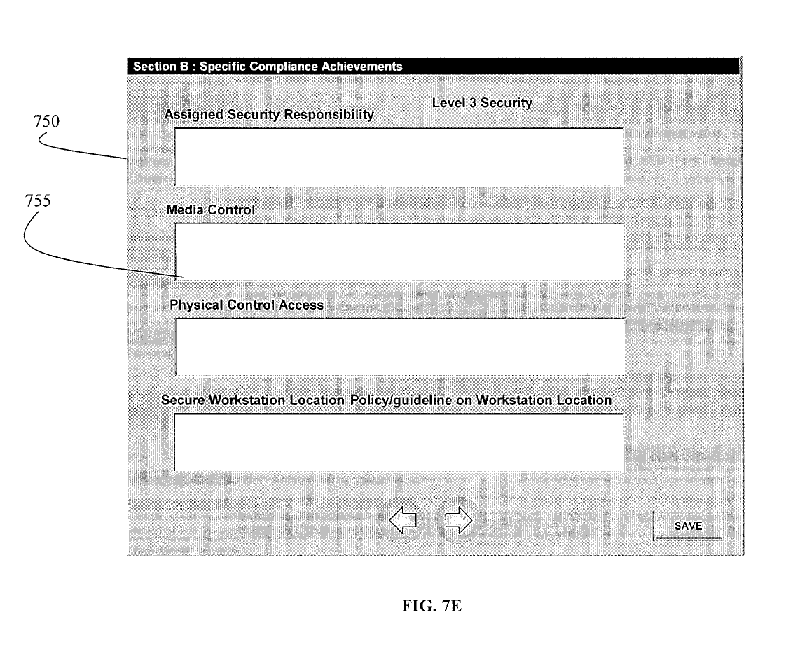

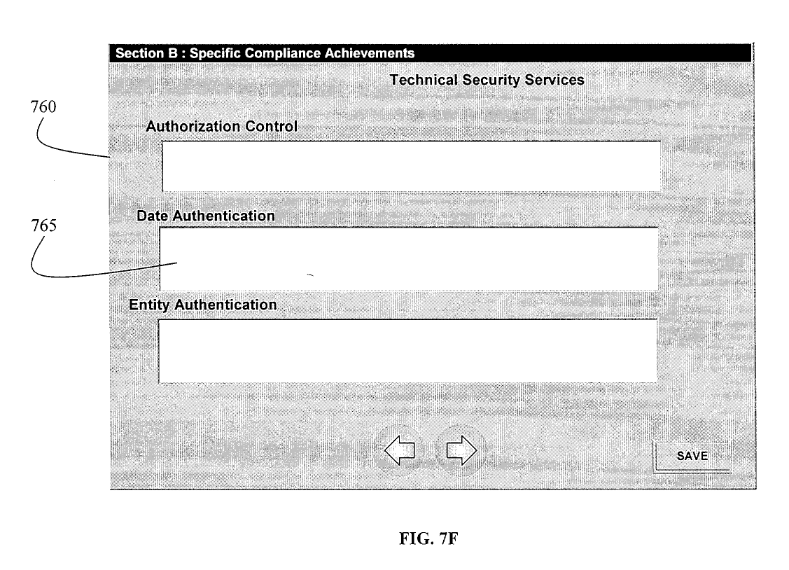

FIGS. 7A-F show an exemplary Compliance Toolkit 130 (CT) that can be used to streamline the form completion process. The CT 130 allows an administrator to setup an entity, contacts of the entity and answer initial compliance questions via a single function. The CT 130 can eliminate the need for the user to complete dozens of forms to prove initiation of the compliancy process. When the covered entity and contacts have been defined by the administrator, the contact can then begin the process of submitting compliancy information.

Navigation buttons are provided for navigating through the multiple screens of the CT 130 tool. Also, a save button is provided to save the current data. Upon selecting the CT 130 tool, a user is directed to the initial compliance screen 700, shown in FIG. 7A. The initial compliance screen 700 allows the user to enter general organizational information. In one embodiment, the general information includes the name, tax ID number, Medicare ID number, and entity type for the covered entity. Once the initial information is entered, a contact person is entered for the covered entity. As shown in FIG. 7B, the contact person information 710 includes first name, middle initial, last name, title, contact type, street address, city, state, zip code, and telephone information. It should be noted that the covered entity need not be the administrator for the Command Center, although they could be one in the same.

Once the entity and contact information is entered, the administrator can enter the compliancy information required under the organization, such as HIPAA compliancy information. FIGS. 7C-D show exemplary forms for capturing compliancy information for each level established by HIPAA. FIG. 7C shows an exemplary form for capturing level 1 compliancy information corresponding to the transaction standards established by HIPAA. Checkboxes 720 are provided for each transaction to denote compliancy, and a description remediation button 730 directs a user to a form for entering descriptions of the transaction. A similar form is provided for the code set standards established by HIPAA.

FIG. 7D shows an exemplary form 740 for obtaining compliancy information, such as information for the rest of the HIPAA standards. A text box 745 is provided to capture information corresponding to each privacy requirement under HIPAA.

FIG. 7E shows an exemplary form 750 for obtaining compliancy information, such as information for the rest of the HIPAA standards. A text box 755 is provided to capture information corresponding to each security requirement under HIPAA.

FIG. 7F shows an exemplary form 760 for obtaining compliancy information, such as information for the rest of the HIPAA standards. A text box 765 is provided to capture information corresponding to each technical security requirement under HIPAA.

Project Calendar

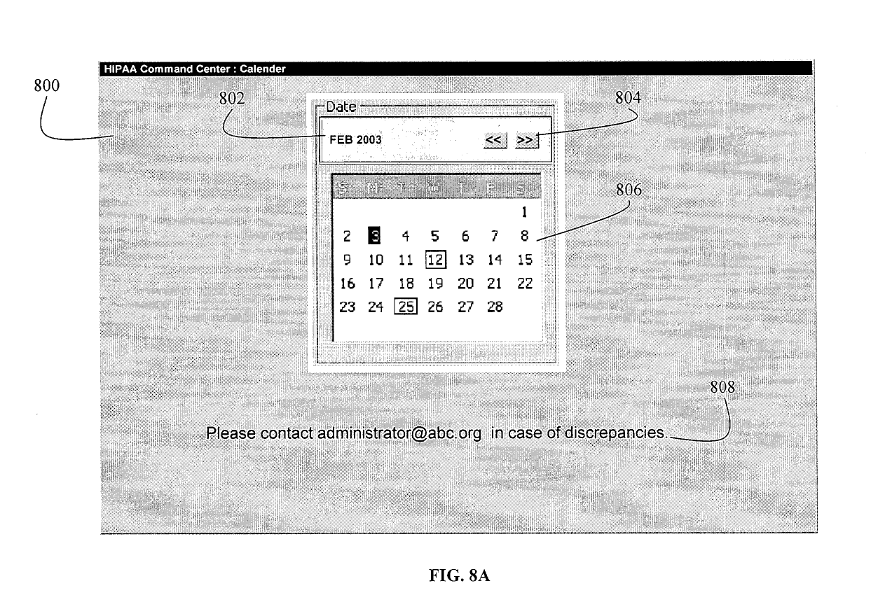

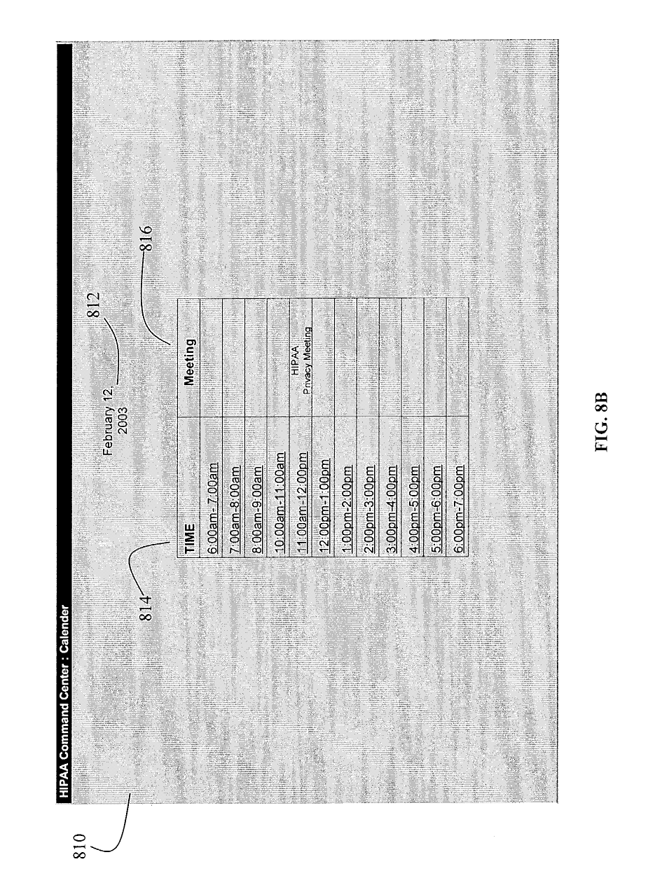

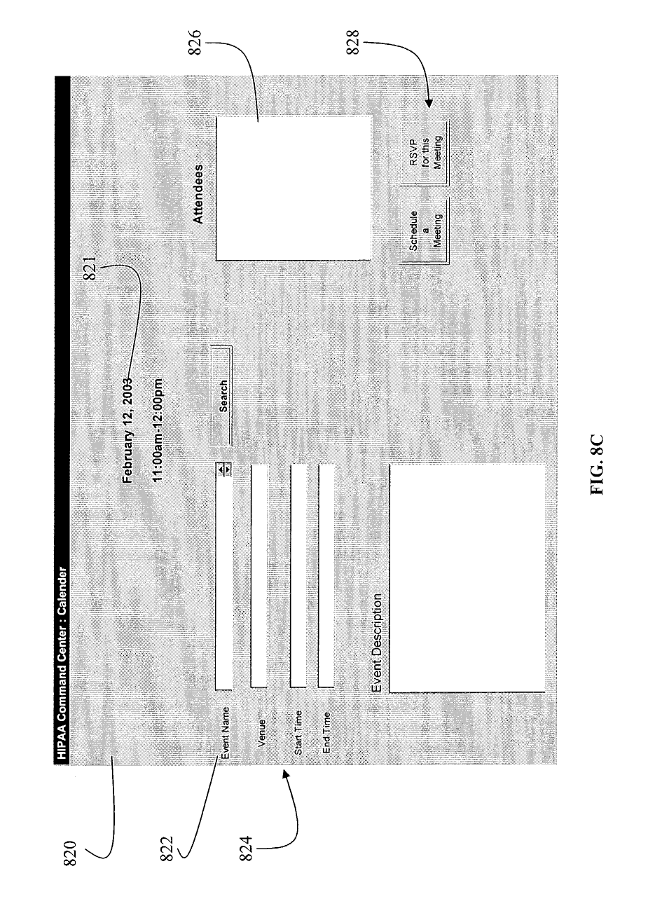

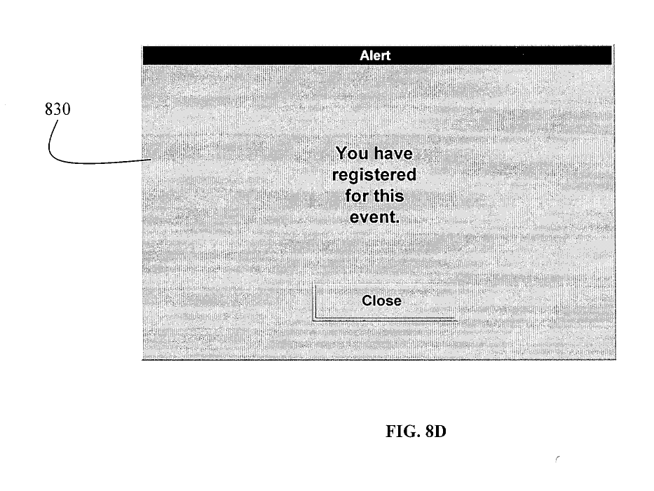

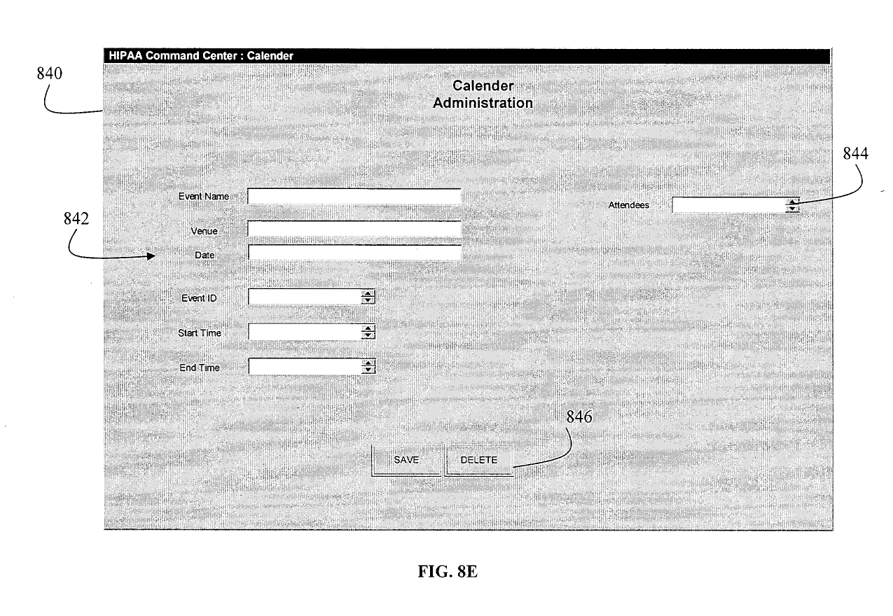

The exemplary Project Calendar 140 (PC) allows a user to view what project meetings have been scheduled and which ones the user should participate in. FIGS. 8A-D show the various screens of the PC 140. FIGS. 8A-B show the month 800 and daily 810 screens. Upon selecting the PC 140, a user is directed to the month view screen 800 for showing an event schedule. The month view screen 800 displays the current month 802, and provides navigation buttons 804 that allow the user to view prior or subsequent months. Optionally, contact information 808 may be displayed in the month view screen 800. The calendar table 806 displays the current month in a known fashion. If an event is scheduled for a particular day, that day will be displayed as a hyperlink that directs the user to the daily screen 810 for the corresponding day. The daily screen 810 displays a title 812 indicative of the selected day. A table is provided with a time column 814 and a meeting column 816. The time column 814 has an entry for each hour of the business day, while the meeting column 816 contains a brief description of the meeting scheduled for that time, if applicable. The time column 814 entries are provided as hyperlinks that direct a user to the specific event information scheduled for that time period.

FIGS. 8C-E show the event views for the PC 140. Each event corresponds to an event related to the regulation or the compliance thereof. A title 821 displays the selected time period. The event view screen 820 is used to add a new event or RSVP to an existing event. An event name text box 822 is provided for entering the name of the event. For example, an event can be a meeting or an appointment. Optionally, the user may search for an existing event. Event information 824 is displayed for existing events, or can be entered for new events. Event information 824 may include venue, start time, end time and an event description. Attendees are entered or displayed in the attendees box 826. Buttons 828 allow a user to RSVP to an existing event or schedule the new event. If a user successfully RSVPs to an event, an alert 830 is displayed. If an administrator is entering event information, they are directed to the administrator setup screen 840. The administrator setup screen 840 allows an administrator to enter event information 842, such as event name, venue, date, event ID, start time and end time. Attendees can be entered in the attendees box 844. Buttons 846 allow the administrator to save or delete the event.

Data Acquisition, Tabulation and Presentation

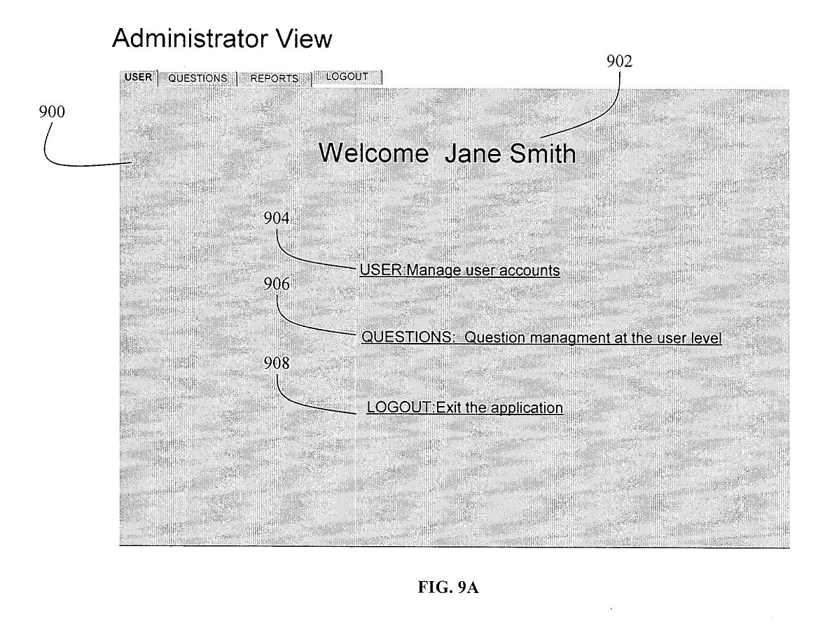

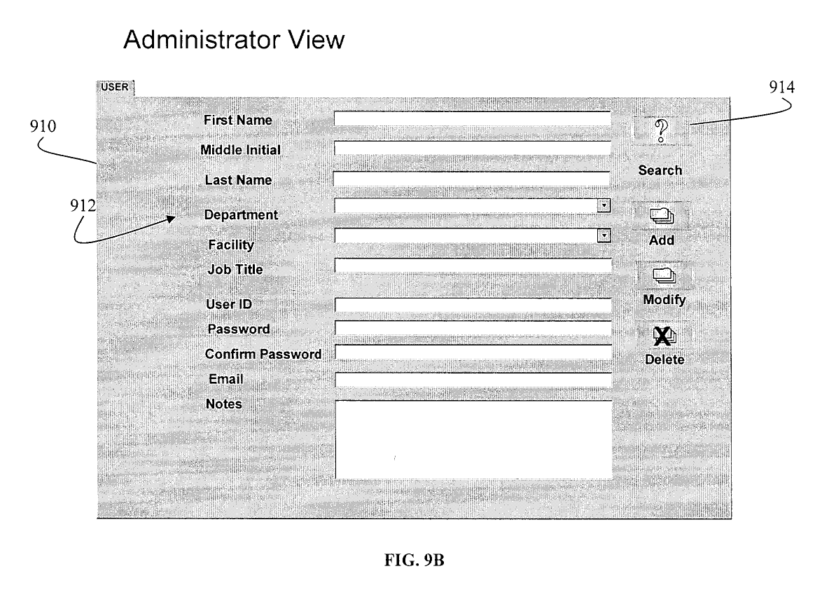

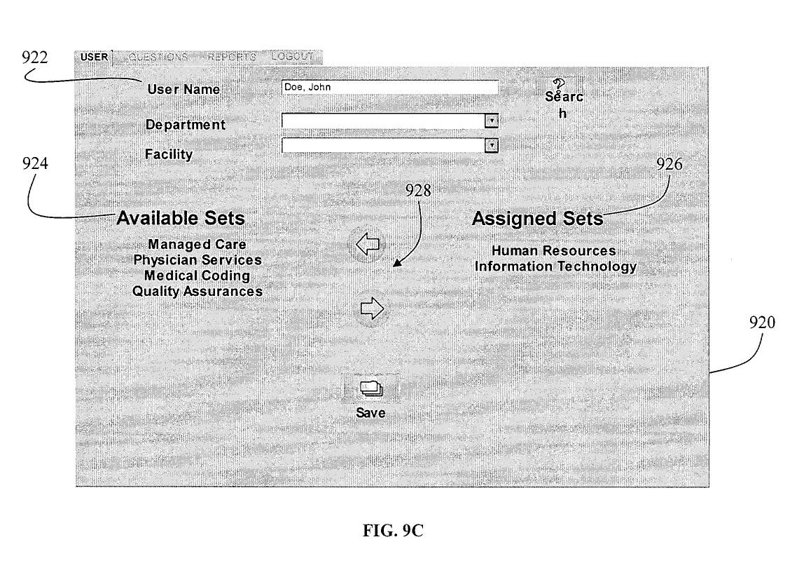

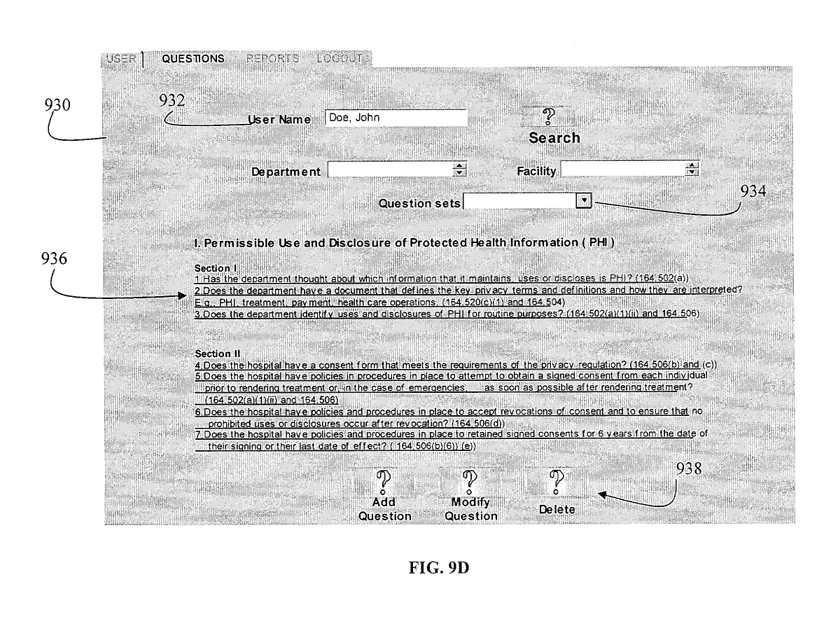

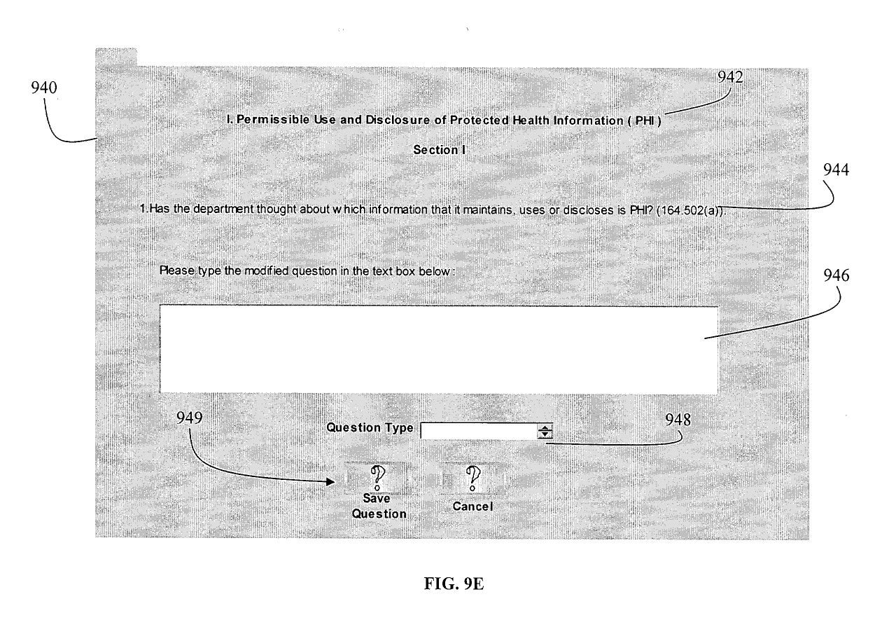

FIGS. 9A-D show the various administrator screens of the Data Acquisition, Tabulation and Presentation 150 (DA). The DA 150 includes the section of the Command Center 100 that allows one to input and analyze how data is collected, viewed and used as outlined by the privacy section of HIPAA. The DA 150 is the functional area of the Command Center 100 where user and question information is entered, and questions are answered by users.

Upon selecting the DA 150, the welcome screen 900 is displayed to the user, such as the administrator. The screen includes a welcome message 902 and hypertext links that direct the administrator to screens that allow the administrator to manage user accounts 904, manage the questions and question sets 906, or log off the system 908. Optionally, tabs may also be provided to direct the administrator to the same screens, as well as to the reports of the PM 120.

Upon selecting the manage user hyperlink 904, the administrator is directed to the user information screen 910. Here, the administrator can add a new user or modify an existing user. User information 912 is displayed or entered. Such information 912 may include a user's first name, middle initial, last name, department, facility, job title, user ID, password, password confirmation, email address, and notes. Buttons 914 are provided that allow the administrator to search for, modify, or delete an exiting user, or add a new user.

Once a user has been defined, the administrator is directed to the question assignment screen 920. Here, the administrator can assign question sets to individual users. User information 922 is provided and includes user name, department and facility information. An administrator can also search for an existing user. The user name is validated to prevent erroneous assignments. The question assignment screen 920 displays a list of available (unassigned) question sets 924 as well as a list of assigned question sets 926. Buttons 928 allow the administrator to assign available question sets, remove assigned question sets, or save the assignment information.

Upon selecting the manage questions hyperlink 906, the administrator is directed to the question set screen 930. The question set screen 930 allows an administrator to add new or modify or delete existing questions in a set. User information 932 includes username, department and facility information. Once a user is selected, the question sets drop-down box 934 provides an administrator with the ability to select the question sets that have been assigned to that user. Upon selection of an assigned question set, a list 936 of the question in that set is displayed. The list 936 is a collection of hyperlinks that direct a user to the modify question screen 940. Preferably, the list is organized hierarchically by section. Buttons 938 are provided that allow the user to add questions to the set and modify or delete existing questions.

The modify existing questions screen 940 allows the administrator to modify an existing question. Sectional information 942 is displayed to put the question into context. The existing question 944 is also displayed. A text box 946 is provided that allows the administrator to enter the modified question. Also, the administrator can classify the questions as a certain type 948. Buttons 949 are provided that allow the administrator to save the modified question or cancel. A similar screen may be used for adding new questions.

FIGS. 1A-C show the various non-administrator screens of the DA 150. Upon selecting the DA 150, a non-administrator is directed to the welcome and assignment screen 1000. A welcome message 1002 is displayed. Summary information 1004 is also provided that summarizes the user's progress in responding to the assigned questions. In one embodiment, the summary information may include a list of assigned question sets, and provides a bar graph indicative of a completion percentage for each question set. The list of assigned questions sets is a list of hyperlinks that direct a user to the response screen 1010 for that question set.

The response screen 1010 includes navigational tools 1012 that display username, department and question set. As a user may be responsible for more than one department or question sets, a drop down box is provided that allows the user to select one of their departments. Another drop down box is provided that allows the user to select a question set that has been assigned to that user and the selected department. Once a question set has been selected, summary information 1014 is calculated and displayed. The summary information 1014 may include the total number of questions in the set, the total number of questions answered, and a percentage complete. Finally, the each question 1016 is displayed with an appropriate means for collecting a response based on the type of question. Buttons 1018 are provided that allow the user to view additional questions, if necessary, save the responses, or exit without saving. Optionally, an information screen 1020 that explains the HIPAA rules associated with the question may be accessible for each question.

News Events

The news events component 160 provides access to the latest news about regulations, compliancy deadlines, or the like. Preferably, the news events information is streamed to the portal 105, such as a HIPAA portal, using known methods.

Online Training

The Online Training 170 provides a venue for users to understand rules and regulations of the act, such as HIPAA. In one embodiment, the online training 170 is provided by HIPAA Academy of Clive, Iowa. The online training 170 provides various levels of training, including general HIPAA classes and more advanced HIPAA certification classes. General classes may include HIPAA awareness training, HIPAA executive overview, HIPAA privacy for beginners, and an introduction to HIPAA security. Certification classes may include classes designed to certify one as a HIPAA administrator, a HIPAA professional, or a HIPAA security specialist. Additionally, certification tests may be made available through the online training.

Knowledge Base Workflow

The Knowledge Base Workflow 180 (KBW) is an online repository for review and storage of the best practice workflows for each business process needing to be compliant with the regulations. The KBW 180 may describe the path a case follows as it is edited, reviewed and published. The success of the KBW 180 depends on the quality and quantity of available information. To assure its success, content in the KBW 180 is preferably accurate, applicable to client needs, and easy to understand. To achieve these high standards, the KBW 180 uses a publishing process that involves contributors, editors, writers (if necessary), and developers. Preferably, the KBW 180 is provided as a user-friendly interface for defining an organization's BPM. An exemplary user-friendly interface in accordance with the present invention includes e-Work™, provided by Metastorm, Inc. of Columbia, Md.

First, contributors from departments submit content, such as information about a business process, to knowledge base on the portal. Contributors make sure the content is accurate, suitable for the KBW 180, and provides a clear answer to a client's (potential) question or problem. Contributors also link the case to one or more problems a client may be experiencing to make sure clients can find the information in the KBW 180.

In the second stage, editors check the information to make sure, among others, that its content is appropriate for the KBW 180 and that the information displays properly in a browser. Editors can call in the help of writers if the text needs modification or the help of developers if the case needs technical adjustments. Once the information has been reviewed and meets all criteria, editors will publish the case. Published information may be immediately available on the portal 105.

Ongoing Compliance Management/Audit

Ongoing Compliance Management/Audit 190 is a set of reports used to detail the ongoing compliance measures, if required by the regulation. For example, structured views of an organization's remediation plan may be displayed with a corresponding structured views of new policies and compliance metrics for the regulation, such as new HIPAA policies and deadline information.

While the invention has been described in conjunction with specific embodiments it is to be understood that many alternatives, modifications, and variations will be apparent to those skilled in the art in light of the foregoing detailed description. It is therefore intended that the foregoing description be regarded as illustrative rather than limiting, and that it be understood that it is the following claims, including all equivalents, that are intended to define the spirit and scope of this invention.

What is claimed:

1. A method for analyzing a current state of compliance with a statutory regulation for a business process of an organization, the method comprising:
establishing an administrator for the organization;
obtaining structural information about the organization;
establishing a user related to the structural information;
obtaining questions about the business process from the administrator;
distributing the questions to the employee;
receiving an answer to the question from the employee; and
generating a current level of compliance based on the answer.

2. The method of claim 1 further comprising:
providing a roadmap from the current level of compliance to a state corresponding to compliance with the statutory regulation.

3. The method of claim 1, further comprising:
generating a report based on the current level of compliance.

4. The method of claim 1, wherein the statutory regulation is a HIPAA mandate.

5. The method of claim 1, wherein the structural information comprises at least one department.

6. The method of claim 5, wherein the department comprises at least one facility.

7. The method of claim 6, wherein the user is responsible for the compliance of at least one facility.

8. A system for analyzing a current state of compliance with a statutory regulation for a business process of an organization, the system comprising:
means for establishing an administrator for the organization;
means for obtaining structural information about the organization;
means for establishing a user related to the structural information;
means for obtaining questions about the business process from the administrator;
means for distributing the questions to the employee;
means for receiving an answer to the question from the employee; and
means for generating a current level of compliance based on the answer.

9. The system of claim 8 further comprising:
means for providing a roadmap from the current level of compliance to a state corresponding to compliance with the statutory regulation.

10. The system of claim 9, further comprising:
means for generating a report based on the current level of compliance.

11. The system of claim 9, wherein the statutory regulation is a HIPAA mandate.

12. The system of claim 9, wherein the structural information comprises at least one department.

13. The system of claim 12, wherein the department comprises at least one facility.

14. The system of claim 13, wherein the user is responsible for the compliance of at least one facility.

15. A system for analyzing a current state of compliance with a statutory regulation for a business process of an organization, the system comprising:
a portal;
a data acquisition tool adapted for receiving structural information about the organization, user information descriptive of a user and related to the structural information, questions about the business process, and answers to the questions;
a database for storing the received information; and
an analysis tool for generating a current level of compliance based on the stored information.

16. The system of claim 15, further comprising:
a compliance tool for submitting the generated current level of compliance to an authority related to the regulation.

17. The system of claim 15, further comprising:
a calendar tool for notifying the user of events related to the regulation.

18. The system of claim 15, further comprising:
a workflow tool for generating a workflow associated with the process.
